(19) United States
(12) Patent Application Publication
(10) Pub. No.: US 2009/0170516 A1
(43) Pub. Date: Jul. 2, 2009

(54) Method And Arrangements For Providing Information Regarding GAN Coverage In The Cellular Radio Communication Network

(75) Inventors: Peter Ostrup, Linkoping (SE); Peter Werner, Linkoping (SE); Jari Vikberg, Jarna (SE)

Correspondence Address: ERICSSON INC., 6300 LEGACY DRIVE, M/S EVR 1-C-11, PLANO, TX, 75024, US

(73) Assignee: Telefonaktiebolaget L M Ericsson (PUBL), Stockholm (SE)

(21) Appl. No.: 12/296,991

(22) PCT Filed: Apr. 12, 2006
(86) PCT No.: PCT/SE06/50073

§ 371 Date: Oct. 13, 2008

(51) Int. Cl. H04W 36/00; H04B 7/00

(52) U.S. Cl. 455/436; 455/41.2

(57) ABSTRACT

The present invention relates to control of GAN-enabled mobile stations operating in a cell of the cellular radio communication network. A signal is transmitted S514 in a cell in a cellular radio communication network, which comprises information that indicates to GAN-enabled mobile stations (MS, MS201) that they may find GAN coverage in the geographical area covered by that cell.

### TECHNICAL FIELD OF THE INVENTION

The present invention generally concerns methods, apparatuses and signals relating to a cellular radio communication. Specifically, the present invention relates to control of GAN-enabled mobile stations operating in a cell of the cellular radio communication network.

### DESCRIPTION OF RELATED ART

The technical specifications for 3rd Generation Mobile System, 3GPP, has standardised the Generic Access to A/Gb Interfaces. This standardisation effort was a successful effort to incorporate Unlicensed Mobile Access (UMA) into the GSM EDGE Radio Access Network (GERAN) specifications.

This new Radio Access Network (RAN) is called Generic Access Network (GAN) and the node corresponding to GERANs BSC is called Generic Access Network Controller (GAN controller).

The GAN may, and mostly will, be an underlay Radio Access Technology covering areas that also are covered by e.g. an overlay GSM Edge Radio Access Network (GERAN) or Universal Mobile Telephone communications System UMTS Terrestrial Radio Access Network (UTRAN). However, GAN can also be used to provide coverage on areas without any overlaying GERAN/UTRAN coverage.

The GAN will be used either as a pure hotspot, complementing technology to GERAN/UTRAN installed by the same or another operator or as an access technology by which an individual consumer may utilize an existing Internet line/broadband connection and his/hers own Access Point (AP) to connect to the GAN controller.

The unlicensed radio technology to be used with GAN is not limited in anyway, but in practise GAN is today supporting Bluetooth or Wireless Local Area Networks (WLAN 802.11) radio access.

A GAN enabled Mobile Station (MS) may operate in a number of preference modes that are either selected by the end user or enforced by the operator:
a) “GERAN/UTRAN-only”
   MS never uses GAN.
b) “GERAN/UTRAN-preferred”
   MS uses GERAN/UTRAN and uses GAN only if GERAN/UTRAN coverage is lost.
c) “GAN-preferred”
   MS uses GERAN/UTRAN, but switches over to using GAN always when GAN coverage becomes available (i.e. despite Of the GERAN/UTRAN coverage).
d) “GAN-only”.
   MS uses only GAN (and never uses GERAN/UTRAN).

For preference modes a) and b) the MS is not really mandated to periodically search for GAN coverage. The most obvious preference mode however (both for the operator and for the end users) is c) and in this case the MS should search for GAN-coverage periodically according to the current GAN standard.

In European Global System for Mobile communications (GSM), the mobile stations are informed about the identity of current cell (Cell Global Identity, CGI) in System Information Type 3 (SI 3) message. Cell Global Identity (CGI) consists of Mobile Country Code (MCC), Mobile Network Code (MNC), Location Area Code (LAC) and Cell Identity (CI). The Mobile Network Code identifies the country in which the GSM Public Land Mobile Network (PLMN) is located and Mobile Network Code is a code identifying the GSM Public Land Mobile Network in that country. So the combination of Mobile Country Code and Mobile Network Code defines one specific mobile network in one specific country. Furthermore, the combination of Mobile Country Code, Mobile Network Code and Location Area Code defines a location area in a specific network. And as last, the combination of Mobile Country Code, Mobile Network Code and Location Area Code and cell Identity (CI) defines a cell in a specific network. A GSM cell is also called GERAN cell in the following descriptions.

The MS is informed about the Mobile Country Code, Mobile Network Code, Location Area Code and cell Identifier for the current cell in a similar way when it is camped on Universal Mobile Telephone Communications System (UMTS) cell. A UMTS cell is also called UTRAN cell in the following descriptions.

The MS includes information about the current overlay GSM or UMTS cell (among other information) when performing the GAN registration procedures towards the GAN controller (initiated by the MS by sending of the GA-RC-REGISTER-REQUEST message to the GAN controller).

In GSM, the MSs are informed of neighbouring cells (in practise a list of Absolute Radio Frequency Code Number ARFCN values for neighbouring GSM cells) in System Information messages (e.g. SI 2 and SI 2bis, SI 2ter and SI 2quater). The MS will use this information when reselecting a cell in IDLE mode.

In a similar way, and also in GSM, the MSs in dedicated mode are informed of neighbouring cells (list of ARFCN values) in System Information (e.g. SI 5 and SI 5bis and SI 5ter). The MS will use this information to perform measurements on the indicated neighbouring cells and to report these measurements to the network. When the MS is in dedicated mode, the network is in total control of performing a Handover to another cell.

The MS is informed about the idle and dedicated mode neighbouring cell lists in a similar way in UMTS.

In prior art, if Handover from GERAN to GAN is to be supported in the whole GSM network, at least one Absolute Radio Frequency Code Number (ARFCN) reserved and configured by the operator for the GAN is sent in system information, specific for dedicated mode, of all GERAN cells in a GERAN that supports underlaid GAN. It is also possible that multiple/different ARFCNs are used in different parts of the network to point to one or to different GAN controllers. This could be the case when multiple GAN controllers are needed in one location or when a specific ARFCN cannot be reserved in the whole network to refer to a specific GAN controller.

When the MS in dedicated mode receives the list of ARFCNs (dedicated mode neighbouring cell list) in the System Information (SI), it does not know which (if any) ARFCN is reserved for GAN and will try to find the ARFCN in GSM also, if it supports the GSM Band associated with the ARFCN. When the MS is in idle mode, the MS performs the cell reselection autonomously i.e. the MS may decide to perform cell reselection from GSM to GAN on its own.

This means that an MS, in “GAN-preferred” mode, should periodically listen for GAN access points using its GAN device (Bluetooth/WLAN sender/receiver) when in GERAN/UTRAN mode, both when in idle and in dedicated mode of operation. While this is the case, the battery standby time of an MS capable of the GAN radio access technology will be shorter than that of an MS not supporting GAN.

Accordingly, it would be highly desirable in cellular radio communication network, to increasing the battery standby time of GAN-enabled MSs.

### SUMMARY OF THE INVENTION

The problem dealt with by the present invention is enabling improved control of GAN-enabled MS (e.g. in “GAN-preferred” mode).

According to a first aspect, the invention includes a method in a cellular radio communication network for controlling GAN-enabled MSs, each of the GAN-enabled MS comprising at least one GAN device and operating in a first cell of the cellular radio communication network. The method comprising transmitting a first signal in the first cell comprising information indicating that the GAN-enabled MSs may find GAN coverage in the geographical area covered by the first cell.

According to a second aspect, the invention includes a method in a GAN-enabled MS comprising a GAN device. The method comprising receiving a first signal transmitted in a first cell of a cellular radio communication network, in which the GAN-enabled MS currently is operating. The first signal including information indicating that the GAN-enabled MS may find GAN coverage in the geographical area covered by the first cell.

According to a third aspect, the invention includes a GAN-enabled MS comprising a GAN device. The GAN-enabled MS comprising means for receiving a first signal transmitted in a first cell of a cellular radio communication network in which the GAN-enabled MS -s currently operating, the first signal comprising information indicating that the GAN-enabled MSs may find GAN coverage in the geographical area covered by the first cell.

According to a fourth aspect, the invention includes a control node in a cellular radio communication network for controlling GAN-enabled MSs operating in a first cell of the cellular radio communication network. The control node comprising means for initiating transmission of a first signal in the first cell, comprising information indicating that the GAN-enabled MSs may find GAN coverage in the geographical area covered by the first cell.

According to a fifth aspect, the invention includes a GAN controller comprising means for receiving a CI from a MS registering through a GAN access point, the CI associated with a first cell in a cellular radio communication network, in which the registering MS is currently operating. The GAN controller comprising means for requesting transmission of a first signal in the first cell, the first signal comprising information indicating that GAN-enabled MSs may find GAN coverage in the geographical area covered by the first cell.

According to a sixth aspect, the invention includes a first signal for controlling GAN-enabled MSs operating in a first cell of a cellular radio communication network. The first signal comprising information indicating that the GAN-enabled MSs may find GAN coverage in the geographical area covered by the first cell.

A general advantage of the invention is that it enables improved control of GAN-enabled MSs.

An advantage of some exemplary embodiments of the invention is that it enables improvements of standby battery life time.

An advantage of some exemplary embodiments of the invention is to simplify Operation and Maintenance.

Still another advantage of some exemplary embodiments of the invention is to improve for the mobile station so it is able to distinguish GAN in the neighboring cell list already when interpreting the system information messages(s) to avoid unnecessary searching of the GAN ARFCN in the GERAN and UTRAN networks.

A further advantage of some exemplary embodiments of the invention, is that a differentiation of public and private coverage is made possible.

Other objects, advantages and novel features of the invention will become apparent from the following detailed description of the invention when considered in conjunction with the accompanying drawings and claims.

### DESCRIPTION OF THE DRAWINGS

FIG. 1 is a block diagram illustrating cellular radio communication network in which the present invention may be employed.

FIG. 2 is a block diagram illustrating cellular radio communication network in which the present invention may be employed.

FIG. 3a-c are flow charts illustrating exemplary embodiments of a method for detecting a GAN registration event according to the invention.

FIG. 4 is a flow chart illustrating exemplary embodiments of a method for detecting GAN coverage according to the invention.

FIG. 5 is a signal diagram illustrating exemplary embodiments of exchange of signals in the cellular radio communication network, wherein a first part of the embodiment according to prior art, and a second part according to the invention.

FIG. 6 is a block diagram illustrating exemplary embodiments of a signal with information according to the invention.

FIG. 7 is a block diagram illustrating exemplary embodiments of a function of a mobile station according to the invention.

FIG. 8a-b are block diagrams illustrating exemplary embodiments of a function of a base station controller and a base station transceiver according to the invention.

FIG. 9 is a block diagram illustrating exemplary embodiments of a function of a GAN controller according to the invention.

### DESCRIPTION OF PREFERRED EMBODIMENTS

The present invention is particularly suited but is not limited to use in second generation digital systems, such as e.g. the European Global System for Mobile communications (GSM) and third generation Public Land Mobile Networks (PLMNS) such as e.g. Universal Mobile Telecommunications Service (UMTS) and CDMA-2000. Being less precise, the present invention is suited for any mobile network.

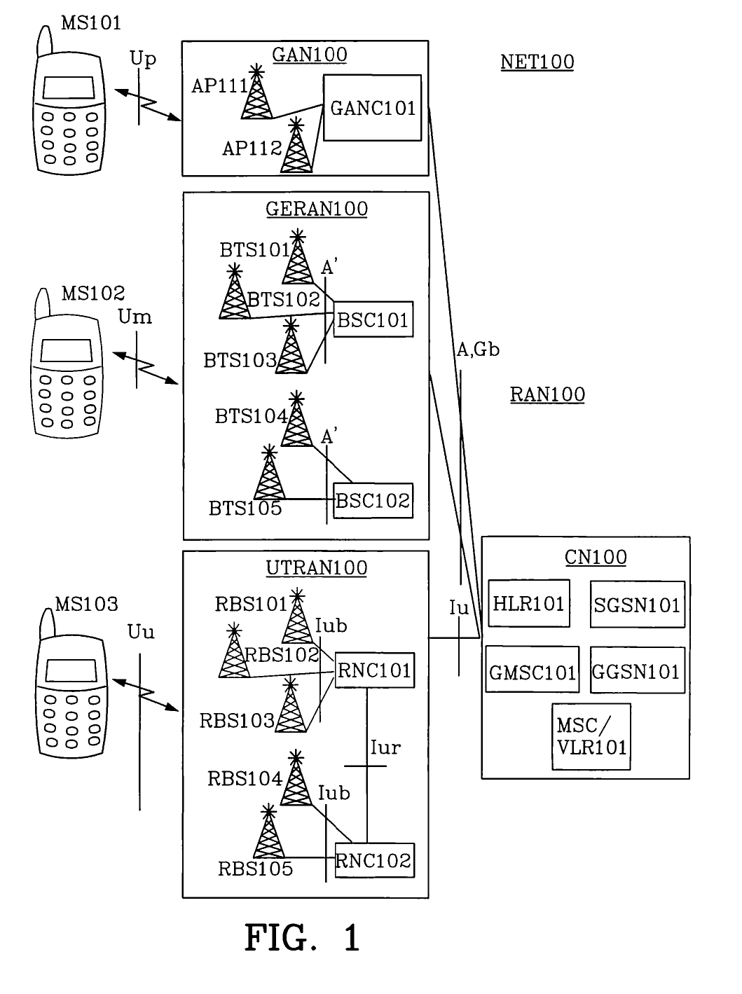

FIG. 1 shows, from the point of view of the invention, the essential parts of a second generation digital system GERAN100, such as the European Global System for Mobile communications (GSM) and the essential parts of a third generation of mobile radio communication UTRAN100 including the Universal Mobile Telephone Communications System (UMTS). Further in FIG. 1 is shown the relatively new Generic Access Network (GAN) GAN100. In second generation digital systems, Mobile Station (MS) MS102 communicates with base station transceivers BTS101-105 through Um interface. The base station transceivers BTS101-103 are controlled by a Base Station Controller (BSC) BSC101, through Abis (A′) interface. Further are base station transceivers BTS104-105 controlled by another BSC BSC102, through Abis interface. The BSCs BSC101-102 are further connected to Core Network (CN) CN100. A Radio Access Network (RAN) RAN100 under control of the BSCs BSC101-102, including the base station transceivers BTS101-105, is commonly referred to as a GSM Edge Radio Access Network (GERAN) GERAN100. The CN CN100 comprises of a mobile switching center (MSC) MSC/VLR101, here shown in combination with a Visitor Location Register (VLR). The interface between the mobile switching center, here combined with visiting location register, MSC/VLR101 and the GERAN network GERAN100 is referred to as an A-interface (A). The CN CN100 comprises also a Serving GPRS Support Node (SGSN) SGSN101 and the interface between the serving GPRS support node SGSN101 and the GERAN network GERAN100 is referred to as the Gb-interface (Gb). This is also applicable to GAN network GAN100 that communicates via interface A to MSC/VLR MSC/VLR101 and communicates via Gb interface to SGSN SGSN101. The MSC/VLR MSC/VLR101 handles the connecting of incoming and outgoing calls. It performs functions similar to those of an exchange of a Public Switched Telephone Network (PSTN), not shown here. In addition to these, it also performs functions characteristic of mobile communications only, such as subscriber location management, jointly with the subscriber registers of the network. Further in the CN CN100, is included the gateway MSC GMSC101 and Gateway GPRS Support Node (GGSN) GGSN101. The MSC/VLR MSC/VLR101 are connected to other networks, such as the public switched telephone network PSTN (and/or an Integrated Services Digital Network ISDN), etc. The base station transceivers BTS101-105, in conjunction with the BSCs BSC101-102, receive information from the MS MS102, process the information and forward the processed information to the MSC/VLR MSC/VLR101. One skilled in the art will appreciate that a base station transceiver BTS101-105 and BSC BSC101-102 pair also receives information from MSC/VLR MSC/VLR101 and transfers such information to one or more MS MS102. At the MSC/VLR MSC/VLR101, information from the BSC BSC101-102 is routed to its destination (e.g., the PSTN when the information is speech or fax/modem data). This is also applicable to SGSN SGSN101, i.e. the MS MS102, process the information and forward the processed information to the SGSN SGSN101 via the base station transceiver BTS101-105 and BSC BSC101-102 pair, as well as information from SGSN SGSN101 is forwarded to MS MS102 via the base station transceiver BTS101-105 and BSC BSC101-102 pair.

The new Radio Access Network (RAN) RAN100 is called Generic Access Network (GAN) GAN100 and the node corresponding to GERANs BSC is called Generic Access Network Controller (GAN controller) GANC101. In the new Generic Access Network GAN100, GAN-enabled MS MS101 communicate with GAN access point transceivers AP111-112 using the relevant unlicensed radio access technology. The GAN access points AP111-112 provide IP connectivity to the MS MS101 and the IP connectivity is used by the MS MS101 to communicate directly with the GAN controller GANC101, through interface Up. The GAN access points AP111-112 forwards the IP traffic both in the uplink and downlink directions between the MS MS101 and the GAN controller GANC101. The GAN controller GANC101, receives information from the MS MS101, process the information and forward the processed information to the MSC/VLR MSC/VLR101. This is also applicable to SGSN SGSN101, i.e. the mobile station MS101, process the information and forward the processed information to the SGSN SGSN101 via the GAN controller GANC101, all depending on which kind of data that is processed, i.e. speech or data or CS (circuit switched) signaling or PS (packet switched) signaling. One skilled in the art will appreciate that the GAN controller GANC101 also receives information from MSC/VLR MSC/VLR101 or SGSN SGSN101 and transfers such information to one or more MSs MS101.

For the third generation of mobile radio communication system such as e.g. the Universal Mobile Telephone communications System UMTS the CN CN100 service nodes connects through the Iu interface to a UMTS Terrestrial Radio Access Network (UTRAN) UTRAN100 part of the RAN RAN100. The UTRAN UTRAN100 includes one or more radio network controllers (RNCs) RNC101-102. Each RNC RNC101-102 is connected to a plurality of radio base stations (RBSs) RBS101-103, RBS104-105 (another name for radio base station RBS is Node-B in a UMTS system) through the Iub interface and through Iur interface to any other RNC RNC101-102 in the UTRAN UTRAN100. Radio communications between the radio base stations RBS101-105 and an MS MS103 are by way of a Uu radio interface.

The RAN interfaces (A, Gb and Iu) are “open” interfaces between the GERAN GERAN100, the GAN GAN100 or the UTRAN UTRAN100 and the CN CN100. These interfaces provide services to/from MSs MS101-103 over the radio interface to the external CNs CN100 in the cellular radio communication network NET100 (and ultimately to external CN end users without having to request specific radio resources necessary to provide those services). Moreover in FIG. 1, the number of each of the components depicted is reduced for the sake of simplicity.

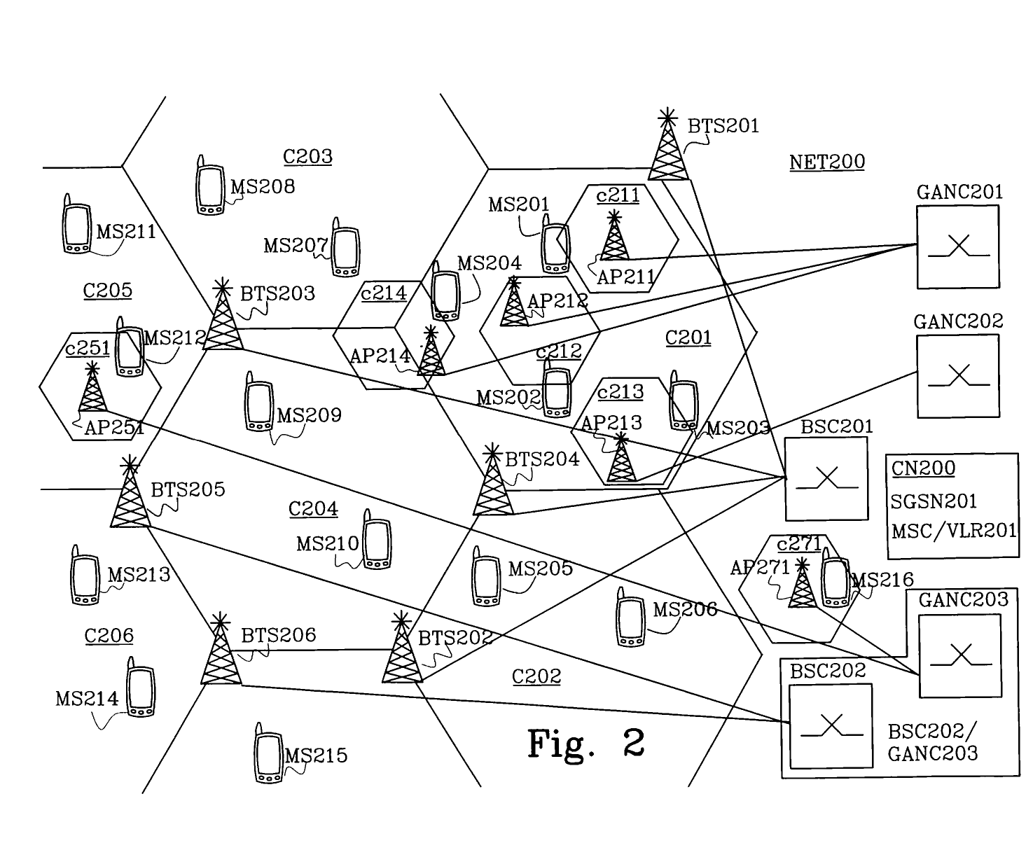

FIG. 2 illustrates a cellular radio communication network NET200 comprising of first GERAN cell C201 with a plurality of MSs MS201-204. In that first GERAN cell C201 four GAN access points AP211-AP214 are shown. A GAN access point is based on the relevant unlicensed radio access technology, for example Bluetooth or WLAN 802.11. Each GAN access point AP211-214 provides a GAN coverage c211-214, a geographical area which is at least partly covered by the first GERAN cell C201. A GAN coverage, e.g. c211, is estimated to be the area that a GAN access point AP211 transmitting can reach a GAN-enabled MS MS201 with its corresponding GAN device on inside the area c211. As can be seen further in FIG. 2, GAN coverages c211-213 of GAN access points AP211-AP213 are all covered by first GERAN cell C201, while fourth GAN access point AP214 has a GAN coverage c214 which stretches over to the neighbouring third and fourth GERAN cells C203-204. It is thereby most likely that the fourth GAN access point AP214 situated in first GERAN cell C201 can handle GAN-traffic to GAN-enabled MSs MS207-210 situated in third and fourth GERAN cells C203-204 if these MSs move to the GAN coverage c214 provided by fourth GAN access point AP214. A first BSC BSC201 is connected to a plurality of base stations BTS201-204, here shown also a second BSC BSC202 connected to fifth-sixth base stations BTS205-206. A first GAN controller GANC201 and a second GAN controller GANC202 are handling the GAN-traffic for the first GERAN cell C201. The reason for this could be e.g. redundancy or capacity needs (i.e. one GAN controller GANC201 doesn't have the capacity to handle all the MSs MS201-202, MS204 in one GERAN cell C201, so e.g. a second GAN controller GANC202 handle MS MS203). A third GAN controller GANC203 is handling all GAN-traffic in fifth GERAN cell C205 and in a seventh GAN cell c271 not inside any GERAN cell, in a combined BSC/GANC node BSC202/GANC203.

The seventh GAN access point AP271 is shown being outside the reach of any base stations BTS201-206 and outside the GERAN cells C201-206. The GAN access point AP271 provides IP connectivity to the MS MS216 and the IP connectivity is used by the MS MS216 to communicate directly with the GAN controller GANC203. Thereby a MS MS216 that is situated in no overlaying GERAN cell, comprising a GAN device, should have its GAN device always turned on.

In general a BSC and GAN controller are separate nodes, as shown in this example by BSC BSC201 and GCN controllers GANC201-202, but in this example is shown also in FIG. 2, a combined BSC/GANC node BSC202/GANC203 that can handle both GAN and GERAN traffic.

Location areas and cells are identified using Location Area Identities (LAI) and Cell Global Identifiers (CGI). Within each network, there will be a set of location areas identified with the Location Area Code (LAC). The Cell Identity (CI) identifies the cell within a location area. The full CGI globally identifies a cell. Further, a cell is defined as the area in which one can communicate with a certain base station. In other words, the term Cell and also a term Control Node should not be interpreted too strictly, instead interpreted to be any area defined to communicate with a transceiver under control of a control node working in any mobile network, here for example related to a GERAN cell/UTRAN cell defined to communicate with a BTS/RBS under control of a BSC/RNC working in GERAN/UTRAN. When not communicating, in idle mode, the MS does not necessarily need to actively announce a shift from one cell to another. If the MS is engaged in CS domain (circuit switched) communication, in dedicated mode, a handover must be performed in order to change from one cell to another. Similarly, when engaged in PS (packet switched) domain communication, a PS handover or a cell change must be performed in order to change from one cell to another. The term Cell Identity (CI) should here therefore not be interpreted too strictly so as to comprise only the Cell Identity CI according to the 3GPP GERAN standard, but instead interpreted as any Cell Identity (CI) capable of identifying the cell either globally or within a location area depending on the situation.

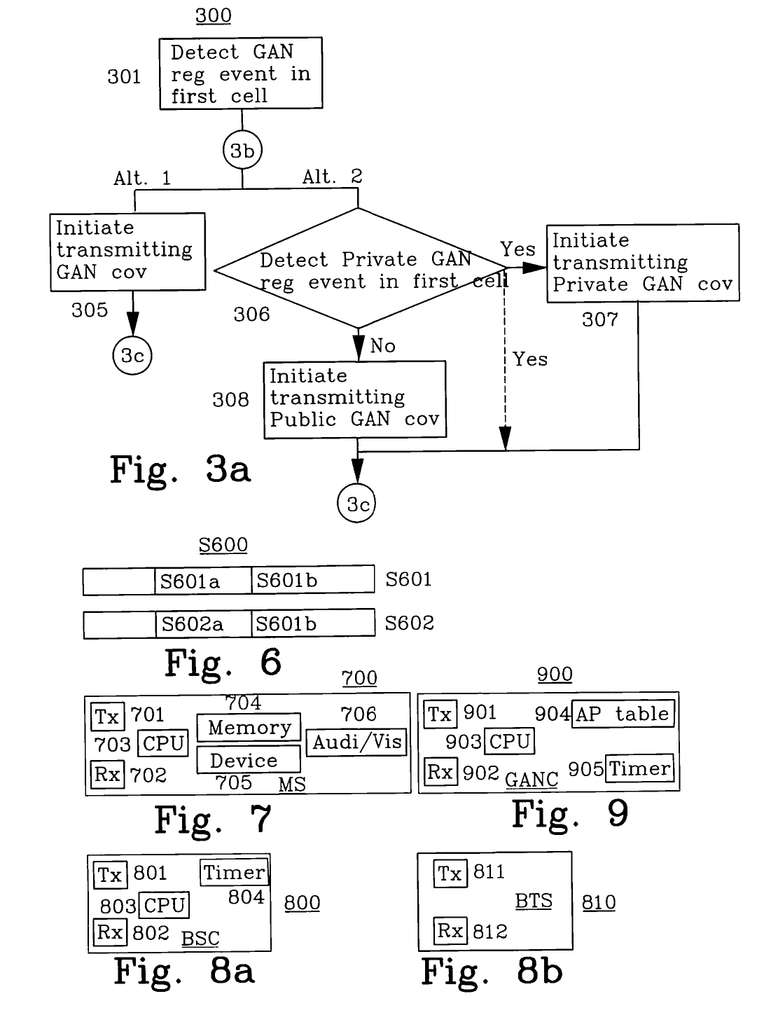

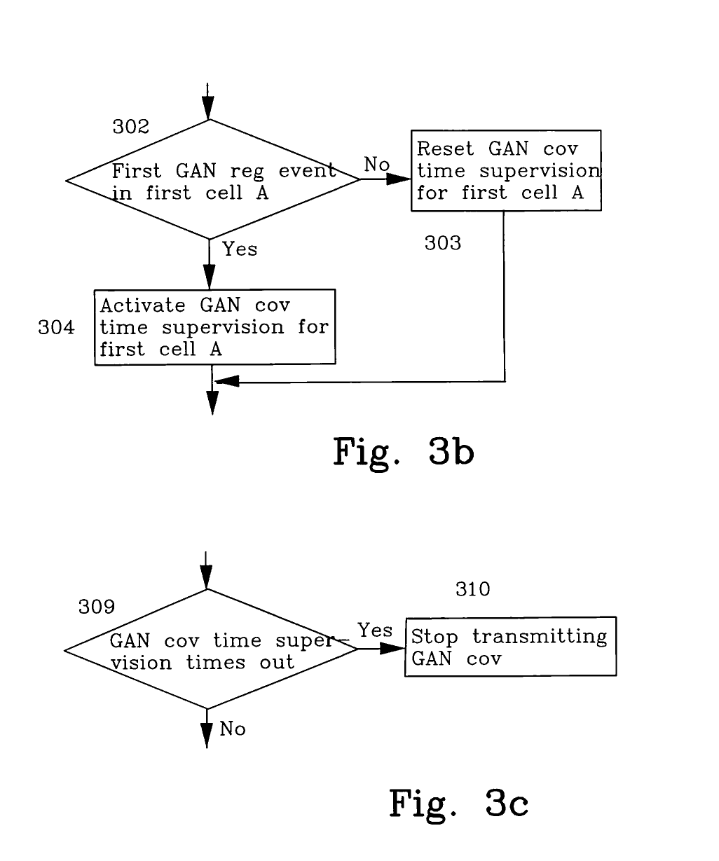

FIG. 3a-c is a flow chart illustrating exemplary embodiments of a method for detecting a GAN registration event according to the invention. According to which some of the nodes of a cellular radio communication network, as illustrated in FIGS. 1 and 2, are modified to incorporate a control of the GAN device of GAN-enabled MSs. As illustrated in FIG. 2, an exemplary first GERAN cell C201, in a cellular radio communication network NET200, GAN-enabled MSs MS201-204 are operating, comprising each at least one GAN device. In first step 301 in FIG. 3a, as an example a GAN registration event in a first GERAN cell C201 is detected.

FIG. 3b-c illustrate a GAN coverage time supervision that may be incorporated into the exemplary embodiments of the method for detecting a GAN registration event according to the invention shown in FIG. 3a. The first part of the GAN coverage time supervision is illustrated in FIG. 3b, and the second part is illustrated in FIG. 3c. A GAN coverage time supervision can be incorporated to be able to supervise by a timer, that after a certain time after a GAN coverage in first exemplary embodiment of the method in FIG. 3a according to the invention, alternative 1, or private and public GAN coverage in second exemplary embodiment of the method in FIG. 3a according to the invention, alternative 2, has been initiated to be transmitted, it can be stopped. As a person skilled in the art appreciates, any construction of a GAN supervision timer can be used, e.g. an algorithm incorporated into a program, or e.g. the GAN supervision timer can be infinite. Further as a person skilled in the art appreciates, without a timer, without FIG. 3b-c incorporated into FIG. 3a, the transmission can be stopped in any manual way, as e.g. by the operator directly. Further as a skilled person in the art appreciates, the initiation of the transmission of GAN coverage in first and second exemplary embodiment of the invention, in FIG. 3a, can be done e.g. manually by the operator, i.e. without the initiation of a GAN coverage time supervision.

FIG. 3b, step 302 it is not for the first time that the GAN registration event in first GERAN cell C201 is detected, a GAN supervision timer in step 303 is reset. If in step 304, it is for the first time a GAN registration event is detected, a GAN coverage time supervision is activated. After the GAN supervision timer is either reset in step 303 in FIG. 3b or activated in step 304, next step is alternative 1 or 2 in FIG. 3a. If no GAN time supervision is incorporated, a direct jump is made to the same next step for alternative 1 or 2 in FIG. 3a.

FIG. 3a, alternative 1, first exemplary embodiment of the invention, step 305, e.g. in a cellular radio communication network NET200 GAN-enabled MSs MS201-204 with at least one GAN device 705 are operating in a first GERAN cell C201 of the cellular radio communication network. The GAN device of the GAN-enabled MSs is controlled by a first signal S600/S601, transmitted in the first GERAN cell C201, comprising the information S601a indicating that GAN-enabled MSs may find GAN coverage c211 in the geographical area covered by the first GERAN cell C201. Another exemplary embodiment, according to alternative 1, could be transmitting a first signal S601 comprising information S601a, wherein the information S601a is comprising at least one GAN ARFCN. GAN ARFCN is primarily used to indicate that there exists GAN coverage in the geographical area covered by the GERAN cell wherein the MS is currently operating.

FIG. 3a, alternative 2, a second exemplary embodiment of the invention, a first signal S601 is transmitted in step 307 comprising information S601a. The first signal S601 comprising information S601a indicating that private GAN coverage c212 may be found in the geographical area covered by first GERAN cell C201. Another exemplary embodiment could be to transmit the first signal S601 with the information S601a about private GAN coverage in an additional information S601b. Further in another exemplary embodiment, the first signal S601 is transmitted, comprising information S601a comprising at least one GAN ARFCN and the additional information S601b comprising “0”. GAN ARFCN is primarily used to indicate that there exists GAN coverage in the geographical area covered by the GERAN cell wherein the MS is currently operating, and “0” that it is private GAN coverage. In alternative 2, another exemplary embodiment, a private GAN coverage c212 is detected in step 306, no transmission of a first signal S601 at all is initiated. It is illustrated by the dashed line and Yes. Having the result that no transmission of a first signal S601 or transmission of a second signal S602 with information S602a with or without additional information S602b is transmitted for private GAN coverage found. For example the second signal S602 is to be transmitted as a system information message S602 which does not include in the information S602a/S602b the GAN Neighbouring Cell Description. In alternative 2, the second exemplary embodiment, a public GAN registration event in first GERAN cell C201 is detected in step 306 and No, a first signal S601 is transmitted in step 308, comprising information S601a. The first signal S601 comprising information S601a indicating that public GAN coverage c211 may be found in the geographical area covered by first GERAN cell C201. Another exemplary embodiment is to add an additional information S602b indicating that a public GAN coverage may be found in the geographical area covered by first GERAN cell C201. Further in another exemplary embodiment, is to transmit the first signal S601 comprising information S601a comprising GAN ARFCN, and the additional information S601b comprising “1”. GAN ARFCN is primarily used to indicate that there exists GAN coverage in the geographical area covered by the GERAN cell wherein the MS is currently operating, and “1” that public GAN coverage exists.

FIG. 3a, a third exemplary embodiment according to the invention, in either alternative 1 or 2, when no GAN coverage in alternative 1 and no public or no private GAN coverage, in alternative 2 is found, a second signal is transmitted S600/S602. The second signal S602 is transmitted comprising information S602a comprising no information. No information S602a in second signal S602 is applicable to an initiating phase, before any GAN coverage or private/public GAN coverage c211 has ever been detected in first GERAN cell C201, and will be when the MS MS201 is receiving the second signal S602 with no information, be indicating to the MS MS201, that any GAN access point in first GERAN cell C201 has not been registered or detected. One exemplary embodiment is for the second signal S602 to be transmitted as a system information message S602 which does not include in the information S602a/S602b the GAN Neighbouring Cell Description. Another exemplary embodiment if no public/private GAN coverage in alternative 2 is found, a second signal S602 comprising information S602a of an GAN ARFCN and additional information S602b “0”. In this embodiment a private GAN coverage c212 may be found, as indicated, and the MS MS201 checks further in a GAN coverage list 704. If not found in list no private or no public GAN coverage is found. Further, another exemplary embodiment could be to transmit a second signal S602 comprising information S602a with empty information, e.g. no GAN ARFCN, and with or without any information in additional information S602b, e.g. “ ”, “0” or “1”.

As a person skilled in the art appreciates, any sign transmitted in first/second information S601a/S602a in first/second signal S601/S602, with or without first/second additional information S601b/S602b can be used to indicate GAN coverage/public or private GAN coverage no GAN coverage/no public or no private GAN coverage. As long as it is determined in advance what the information means to MS.

In FIG. 3c if the GAN supervision timer is incorporated, a check is made in step 309 if the GAN supervision timer has timed out, if Yes, step 310, GAN coverage is stopped transmitting. Actually, different embodiments of how to stop transmitting GAN coverage according to the invention, when the timer has timed out, depending on if alternative 1 or 2 of the exemplary embodiments is chosen. For example one embodiment of stopping transmitting GAN coverage (first signal S601) is by transmitting the second signal S602 comprising information S602a, with/without additional information S602b according to what is described above for third exemplary embodiment when no GAN coverage in alternative 1 and no public and no private GAN coverage in alternative 2 is found.

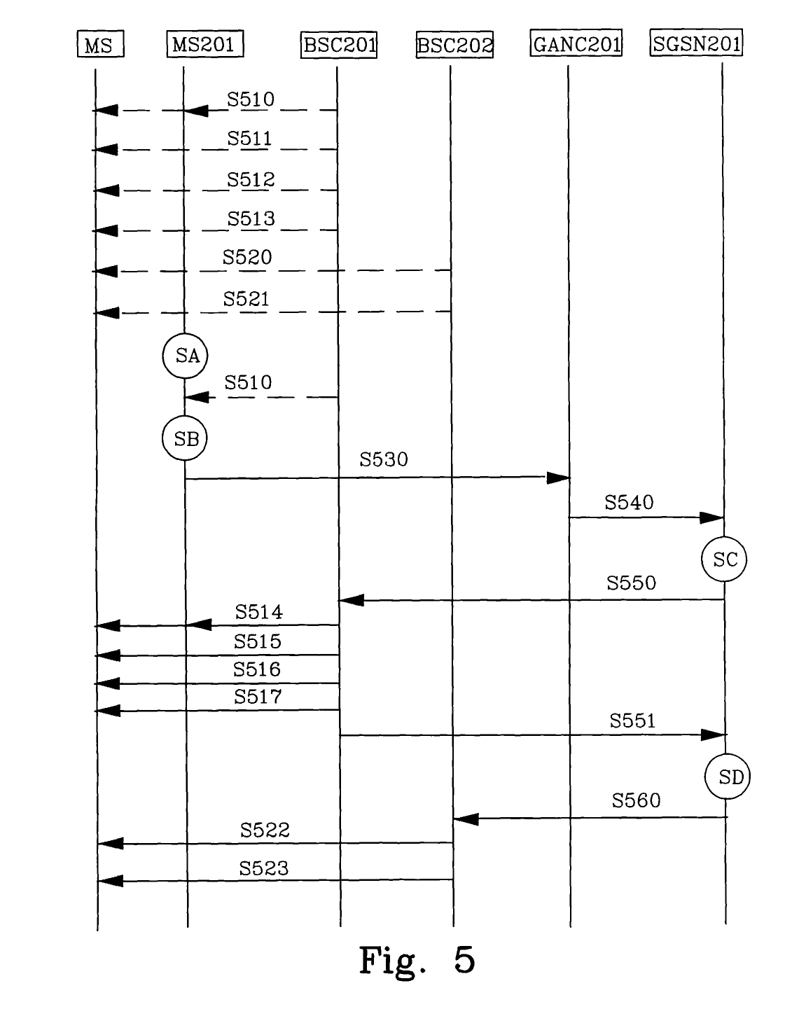

FIG. 3a-c does not describe on what premises either GAN registration event or private and public GAN registration event in first GERAN cell C201 is detected. Further is not neither described here, how the transmission can be extended to neighbouring cells, i.e. to not only be performed in the first GERAN cell C201, where the GAN coverage or private/public GAN coverage is first detected, see instead further down in the description for FIG. 5.

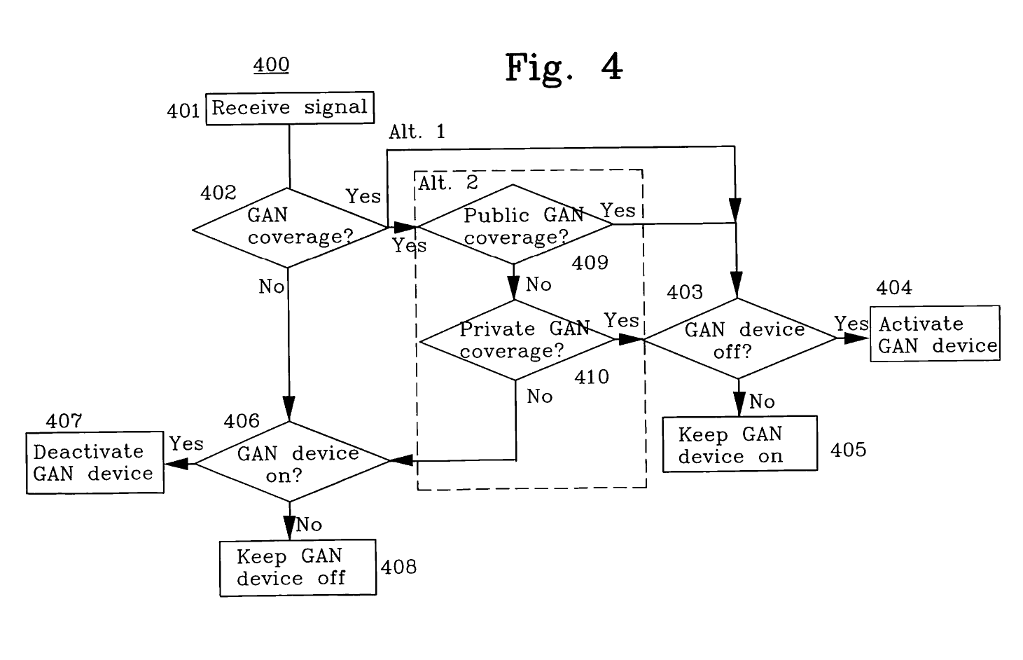

FIG. 4 is a flow chart illustrating exemplary embodiments of a method for detecting GAN coverage according to the invention. According to which a GAN-enabled MS, having at least one GAN device is modified to incorporate a control function that may activate and deactivate the GAN device.

The exemplary MS MS201/205 in step 401 receives a signal S600. If, in step 402, describing alternative 1 of the first exemplary embodiment of the invention, a first signal S601 comprises information S601a indicating that the GAN-enabled first MS MS201, operating in a first GERAN cell C201, may find GAN coverage c211 in the geographical area covered by the first GERAN cell C201. In another exemplary embodiment in step 403, if the GAN device is off, the GAN device may be activated, as in step 404. If it is on already, as in step 405 the GAN device may be kept on. An alternative way is to provide an audiovisual indication (703), to the user of the GAN-enabled MS upon receipt of the first signal S601 comprising information S601a that GAN coverage is found. The audiovisual indication may indicate to the user that he/she may be able to activate its GAN device as GAN coverage may be found in the geographical area covered by first GERAN cell C201. Another exemplary embodiment, if first signal S601 comprising information S601a comprising at least one GAN ARFCN indicating in the same way to MS MS201 that GAN coverage c211 may be found in first GERAN cell C201. In alternative 2, of the second exemplary embodiment of the invention, the GAN coverage can be differentiated between public and private GAN coverage as in step 409 and 410. The first signal S601 comprises information S601a differentiating if first MS MS201 in FIG. 2 can possibly be able to receive and transmit signals from a public or private GAN access point AP211/AP212, i.e. having public or private GAN coverage c211/c212, and that public or private GAN coverage may be found in the geographical area covered by the GERAN cell C201. One exemplary embodiment explained for FIG. 3a, the first signal S601 comprises information S601a comprising an GAN ARFCN, which is only received by first MS MS201 if public GAN coverage is found, and private GAN coverage can never be detected if not the GAN device on the MS MS201 is turned on manually. The second exemplary embodiment is receiving the first signal S601 comprising information S601a comprising an indication that either public or private GAN coverage can be found in the geographical area covered by first GERAN cell C201. Another exemplary embodiment is receiving an additional information S601b indicating that either public or private GAN coverage can be found in the geographical area covered by first GERAN cell C201. Another exemplary embodiment, could be when the first signal S601 comprises information S601a comprising an GAN ARFCN, and the additional information S601b is a “1”, for public GAN coverage and the additional information S601b is a “0” for private GAN coverage, see step 409 and answer Yes for public, and step 410 and answer Yes for private. See further above steps 403-405. If private GAN coverage is indicated a further investigation in this exemplary embodiment would be necessary. In a MS memory 704 is e.g. a list (e.g. a private GAN coverage list) stored of all cells, where private access points AP212 have been accessed manually. Cells in the list are identified using the relevant identifiers for each different RAN type. For example, the CGI is used for GERAN cells. If e.g. the CGI of the GERAN cell C201 can be found there, it means that private GAN coverage can be found in that GERAN cell C201, see step 410 and Yes. See above step 403-405. If the CGI of the GERAN cell C201 can not be found in the list, it means that no private GAN coverage can be found, see step 410 and No. See above step 406-408.

FIG. 4, a third exemplary embodiment according to the invention, in either alternative 1 or 2, when no GAN coverage in alternative 1 and no public or no private GAN coverage, in alternative 2 is received in a second signal. If, in step 402, third exemplary embodiment, the exemplary second signal S602 comprises information S602a indicating that the GAN-enabled second MS MS205 operating in a second cell C202 may find no GAN coverage in the same geographical area as is covered by the second cell C202, the GAN device of second MS MS205 may be deactivated, step 407. If the GAN device is already off no need to turn the device off is necessary, as in step 408. An audiovisual indication to the user of the MS MS201 could also be used to indicate to the user that he/she may turn the GAN device off. Further, corresponding to the third exemplary embodiment for FIG. 3a, a second signal S602 comprising information S602a with no information, e.g. no GAN ARFCN and with or without the additional information S602b, e.g. “ ” “0” or “1”, all indicating to the MS MS201 that neither private or public GAN coverage can be detected somewhere in GERAN cell C201. Receiving a second signal S602 with no information S602a is applicable to an initiating phase, before any GAN coverage or private/public GAN coverage c211 has ever been detected in first GERAN cell C201, and will be when the MS MS201 is receiving the second signal S602 with no information, be indicating to the MS MS201, that any GAN access point in first GERAN cell C201 has not ever been registered or detected, and the GAN device 705 may be turned off/deactivated.

Although the invention has been described in FIG. 1-4 mostly with reference to a GSM/GERAN/GAN cellular radio communication network it should be understood that it is a straightforward matter for the person skilled in the art to adapt the invention to other cellular radio communication network, for example UMTS/UTRAN/GAN and those based on OFDM and CDMA. Being less precise, the present invention is suited for any mobile network. This is also applicable to FIG. 5-9.

FIG. 5 is a signal diagram illustrating exemplary embodiments of exchange of signals in the cellular radio communication network, wherein a first part of the exemplary embodiments according to prior art, see dashed arrows, and a second part according to exemplary embodiments of the invention. Specifically, the signal diagram illustrating the exchange of signals between the MSs and the RAN and the CN when performing the methods illustrated in FIG. 3-4, in the exemplary UTRAN/GERAN/GAN cellular radio communication network of FIG. 1-2. At first, in this example of what is being transmitted in first GERAN cell C201 and according to prior art, e.g. a system information signal S510 is transmitted from the first BSC BSC201 both in idle and dedicated mode to all MSs MS201-204 in first GERAN cell C201 in FIG. 2. As a person ski-led in the art appreciates, which is not shown in FIG. 5, actually the system information signal S510 is transmitted by the base station transceiver BTS201 in first GERAN cell C201, and the system information signal S510 is only initiated to be transmitted by the first BSC BSC201. The same is valid for signals S514-517 and S522-523 in FIG. 5, and to all GERAN cells C201-206 in FIG. 2 and to the methods in FIG. 3a-c. Further, according to prior art, in the exchange of signals in FIG. 5, the exemplary system information signals S511-513 are (initiated to be transmitted) transmitted to MSs MS205-206 and MS207-208, and MS209-210 camped in second C202, third C203 and fourth C204 GERAN cells by first BSC BSC201 in control of those GERAN cells. If the fifth C205 and sixth C206 GERAN cells are controlled by a second BSC BSC202, as in this example, the system information signals S520 and S521 are transmitted by second BSC BSC202 in idle and dedicated mode to corresponding MSs MS211-212 in GERAN cell C205 and MS213-214 in GERAN cell C206. A combined BSC and GAN controller is shown as BSC202/GANC203 in FIG. 2, see earlier comment on this, but in FIG. 5 is the exchange of signals only with first and second BSC BSC201 and BSC202 illustrated, implying that the GAN controller GANC201 being separated from the BSC nodes BSC201,BSC202. As a person skilled in the art appreciates, either a combined or a separate node is possible.

FIG. 5, at step SA, according to prior art, symbolizes an exemplary registering MS MS201 camping (currently operating) in first GERAN cell C201 illustrated in FIG. 2, and the same system signal S510 is still being transmitted by first BSC BSC201, which is received by registering MS MS201. If it is for the very first time a registering event is detected in first GERAN cell C201, it would be applicable to the initiating phase, where the MS MS201 for example receives the second signal S602/S510, transmitted as a system information message S602 which does not include in the information S602a/S602b the GAN Neighbouring Cell Description.

FIG. 5, at step SB, a first part of a GAN registration event according to prior art is detected, in first GERAN cell C201. Step SB, is here illustrated to be performed by the registering MS MS201. Not illustrated by step SB is the possibility to make the GAN registration event be performed e.g. by means of a manual configuration of the registering MS MS201, or e.g. by an operator directly. This could be for example the case when the operator installs a hotspot type public GAN coverage and the GAN access point is installed by the operator personnel. If the GAN registration event is performed by the registering MS MS201, the first MS MS201 has to have its GAN device activated, and a first GAN access point AP211 is transmitting signals which are reached by the registering MS MS201 (not illustrated in FIG. 5). The identity of the current GAN access point AP211 is transmitted by the GAN access point AP211 and is reached by the registering MS MS201. The identity of the GAN access point AP211 may also be known to the GAN controller GANC201 by communication between the GAN controller GANC201 and MS MS201 based on for example the public IP address used by the MS MS201 for this communication. In this example, the first GAN controller GANC201 is in control of some of the GAN access points AP211-212, AP214 in first GERAN cell C201. In prior art, the exemplary registering MS MS201, gets the information of the CGI transmitted in the system information signal (e.g. system information signal S510 comprises the CGI of first GERAN cell C201)). The CGI is corresponding to the exemplary first GERAN cell C201 in FIG. 2, where the exemplary registering MS MS201 is camping (currently operating) for the moment. Further in prior art, during a handover towards a GAN cell c211 (GAN coverage c211) provided by a GAN access point AP211, the registering MS MS201 first registers with the relevant GAN controller GANC201 and sends the CGI of the current GERAN cell C201 and the identity of the current GAN access point AP211 in e.g. a GA-RC-REGISTER-REQUEST message to the GAN controller GANC201 serving the current area of the GAN access point AP211, as illustrated by signal S530 in FIG. 5. As a person skilled in the art appreciates, which is not shown in FIG. 5, actually the GA-RC-REGISTER-REQUEST message S530 is transmitted through the GAN access point AP211 in first GERAN cell C201 to the GAN controller GANC201. The GAN controller GANC201 gets the information of the identity of the GAN access point AP211 from the MS MS201 or as explained above by direct communication between the GAN controller GANC201 and the MS MS201. The information of the CGI received by the GAN controller GANC201, is the current GERAN cell C201 for the registering MS MS201, which indicates that the GAN access point AP211 is somewhere in GERAN cell C201.

In 3GPP TS 48.018, the generic procedures for transparently transporting RAN data through the CN between e.g. the two BSCs BSC201 and BSC202 in FIG. 2, are defined as RAN Information Management (RIM) procedures. Further, when data is to be transported for a new application, this application must be defined in TS 48.018. According to exemplary embodiments of exchange of signals in the cellular radio communication network according to the invention, for example a new RAN-INFORMATION MESSAGE, here in FIG. 5 illustrated as the signals S540, S550, S551, S560, could be used to initiate the GAN device control function in the BSCs BSC201 and BSC202 in control of the GERAN cells C201-206 in FIG. 2.

The method steps 302-304,309-310 illustrated in FIG. 3b-c, according to one exemplary embodiment of the invention, takes also into consideration if it is for the first time a registration event occur in first GERAN cell C201, or if a too long time has passed since last registration event occurred, and a deactivation of the GAN access points AP211-214 in exemplary first GERAN cell C201 can be assumed. This could for example be accomplished by a GAN supervision timer placed in the GAN controller GANC201 or in the BSC BSC201 in FIG. 5. The GAN supervision timer placed for example in GAN controller GANC201 could be activated (or reset depending if step 303 or step 304 in FIG. 3b) by signal S530 and if instead placed in BSC BSC201 activated (or reset depending if step 303 or step 304 in FIG. 3b) by signal S550. Further to be mentioned a GAN registration event is detected each time a GAN-enabled MS with its GAN device turned on finds GAN coverage.

A second part of the GAN registration event is detected at step SB, corresponding to step 301 in FIG. 3a, and according to first exemplary embodiment of exchange of signals in the cellular radio communication network according to the invention. An exemplary new RAN-INFORMATION message S540 is transmitted from the first GAN controller GANC201 to the serving GPRS SGSN201. The message S540 comprises e.g. the GERAN CGI corresponding to the CGI received from the registering MS MS201 transmitted to the GAN controller GANC201 in signal S530, as described above.

The use of RIM is just an example of one of the possible ways to communicate from the GAN controller GANC201. In the combined BSC/GANC case, as depicted in FIG. 2 as BSC202/GANC203, the communication can be handled internally in the combined node i.e. without the use of RIM. Another example for UTRAN is to use the Iur-interface between RNCs or possibly also between a GAN controller and a RNC. These principles apply for all relevant embodiments of this invention.

FIG. 5, at step SC, the registration event continues by the second exemplary embodiment of the invention where the SGSN SGSN201 uses the included CGI to route the message to the correct target control node (relevant control node). Here, in this example, the CGI of the first GERAN cell C201 is used to route the request to the correct first BSC BSC201 in the new RAN-INFORMATION message, S550 which can be identical to S540. Upon receiving the request, according to a third exemplary embodiment of the invention, the first BSC BSC201 initiates the implied first base station transceiver BTS201 to transmit the first signal S601,S514 with the information S601a indicating that GAN-enabled MSs MS201-204 may find GAN coverage c211 in the geographical area covered by the first GERAN cell C201.

The signal S601,S514 with the information S601a indicating that GAN-enabled MSs MS201-204 may find GAN coverage c211 in the geographical area cove-red by the first GERAN cell C201, can be transmitted in only the first GERAN cell C201 where the GAN coverage c211 is found or to neighbouring GERAN cells C202-204 to also consider for example the situation of when the transmission from a GAN access point covers neighbouring GERAN cells as illustrated by fourth GAN access point AP214 in FIG. 2. The decision to activate the GAN coverage indication also in GERAN neighbouring cells C202-204 and in cells C205-206, in this exemplary embodiment, could be a local decision in the BSC BSC201 or the GAN controller GANC201 could indicate to the BSC BSC201 in the new RAN-INFORMATION message S540-S550 that the GAN coverage indication should also be activated to neighbour GERAN cells, e.g. C202-204 and C205-206 of GERAN cell C201. In this example S514 is used in GERAN cell C201 to indicate the possible GAN coverage c211. If GAN coverage c211 is also going to be indicated in second GERAN cell C202, then S515 would be used for this. In the same way, S516 would be used for third GERAN cell C203 and S517 would be used for fourth GERAN cell C204.

The following description shows the principles of a fourth exemplary embodiment, when the BSC201 informs BSC202 about the newly detected GAN coverage. However, this is not very likely the scenario in the example shown in FIG. 2 as the BSC202 do not control any neighbouring cells to the cell C201. If the signal S601,S522 with the information S601a is also to be transmitted in neighbouring GERAN cells C205-206 and the GERAN cells C205-206 are controlled by another BSC, here e.g. BSC202, further new RAN-INFORMATION messages need to be transmitted S551, S560. In FIG. 5 is illustrated how a new RAN-INFORMATION message S551 is transmitted from the first BSC BSC201 to the SGSN SGSN201, comprising the CGI of fifth and sixth GERAN cells C205 and C206. This can be performed either by indicating multiple CGIs in one new RAN-INFORMATION message as shown in FIG. 5, or by using multiple new RAN-INFORMATION messages, e.g. one for each GERAN cell, signal S551 for fifth GERAN cell C205, and not shown e.g. signal S552 for sixth GERAN cell 206. The decision to do this would need to based on knowledge in BSC201 that the GERAN cells C205-206 included reside in the same BSC, here BSC202. In step SD, the SGSN SGSN201 uses the CGIs corresponding to the fifth C205 and sixth C206 GERAN cells, to route the request to the correct BSC BSC202 in another new RAN-INFORMATION message, S560. Upon receiving the request the second BSC BSC202 initiates the implied fifth BTS BTS205 and sixth BTS BTS206 to transmit the signal S601,S522,S523 in fifth C205 and sixth C206 GERAN cells with the information S601a indicating that GAN-enabled MS may find GAN coverage in the geographical area covered by the neighbouring GERAN cells C205-206. More specifically upon receiving the request the second BSC BSC202 initiates the first signal S601 with the information S601a indicating that GAN enabled MSs MS211-212 in fifth GERAN cell C205 may find GAN coverage in fifth GERAN cell C205 to be transmitted in fifth GERAN cell C205, here e.g. by S522, and the first signal S601 with the information indicating that GAN enabled MSs MS213-214 in sixth GERAN cell C206 may find GAN coverage in sixth GERAN cell C206 to be transmitted in sixth GERAN cell C206, here e.g. by S523.

In general the transmission of first signal S601 comprising the information S601a is performed in at least the first GERAN cell (e.g. C201) wherein the first registration event is detected (e.g. MS201 and AP211). It may be necessary to expand the transmission to neighbouring cells informing the MSs of their opportunity to use its GAN device for communication in those cells. As illustrated in FIG. 2, fourth GAN access point AP214 is transmitting over into third GERAN cell C203 and fourth GERAN cell C204, in addition to first GERAN cell C201. Thereby a conclusion could be for this case of the fourth GAN access point AP214 being activated, also the MSs MS207-208 in third GERAN cell C203 and MSs MS209-210 in fourth GERAN cell 204, as well as the MS MS204 in first GERAN cell C201 should be informed of that GAN coverage may be found in first GERAN cell C201, third GERAN cell C203 and fourth GERAN cell C204.

The Absolute Radio Frequency Code number (ARFCN) is today a term being used in GERAN/GAN at the measurement reporting level and is a term corresponding to “BSIC” the Base Station Identity Code of the base station. The ARFCN identifies a GERAN cell in the radio level. In a similar way, “Frequency Code” and “Scrambling Code” identify an UTRAN cell. Thereby the term GAN ARFCN should here therefore not be interpreted too strictly so as to comprise only an ARFCN according to the 3GPP GERAN, GAN or UTRAN standards, but instead interpreted as any number/name capable of identifying the that there exists GAN coverage in the geographical area covered by the GERAN cell wherein the MS is currently operating. A GAN controller is associated with at least one GAN ARFCN, and one GAN controller can be associated with generally at least one GAN coverage, and a GAN coverage is associated with a GAN access point, operating at least partly within the same geographical area covered by the GERAN/UTRAN cell wherein the GAN controller is operating. An exemplary embodiment of the invention could be e.g. to let the GAN ARFCN indicate the identity of the GAN controller, e.g. here GAN controller GANC201, see further down in the description for private and public GAN access points being controlled by a GAN controller.

According to the exemplary second embodiment of the invention illustrated in FIG. 3a-c and FIG. 4 GAN access points AP211-214 can be differentiated between public and private GAN access points. This also concludes that a first GAN controller GANC201 can handle both public (e.g AP211) and private (e.g. AP212) GAN access points and also handle both 802.11 and Bluetooth radio access. A public GAN access point, e.g. first GAN access point AP211, is a GAN access point that can be used by all GAN-enabled MSs MS201-204 (e.g. Hotspot access point at airport). A private GAN access point, e.g. here second GAN access point AP212 is an GAN access point that can only be used by a limited group of GAN-enabled MSs MS203 (e.g. at home with Bluetooth paired to third MS MS203).

One GAN Controller, here e.g. first GAN controller GANC201 in FIG. 2, can handle both private and public GAN access points and also both 802.11 and Bluetooth as described above. An exemplary embodiment of the invention is to use the GAN ARFCN to identify the GAN controller and is currently used in the existing GAN specifications for handover only and to use to route the handover request from the BSC BSC201 to the correct GAN controller GANC201 via the CN CN201. Each GAN controller GANC201 may be identified using the GAN ARFCN and so it may be enough to use only one GAN ARFCN for both private and public GAN access points and also both 802.11 and Bluetooth.

FIG. 5, at step SB, the GAN registration event is detected, the second exemplary embodiment of the invention, alternative 2 in FIG. 3a, according to which step SB take into consideration that GAN access points AP211-214 can be differentiated between public and private GAN access points. The GAN controller GANC201 receives the identity of the GAN access point AP211,AP212 in S530 (or by direct communication between the GAN controller and the MS as defined earlier) and is able to distinguish between public and private GAN access points, e.g. by evaluating in an GAN access point table AP table 904 (e.g. different keys: SSID or MAC address of the GAN access point or the public IP address used by the MS for communicating with the GANC) the GAN access point identity. In one exemplary embodiment the GAN controller GANC201 shall only forward the reported CGI via RIM, here e.g. signal S540,S550 in FIG. 5, to the BSC, here e.g. first BSC BSC201, if a registering MS, here e.g. first MS MS201, is using a public GAN access point, here e.g. first GAN access point, AP211 for registration. Thus the signal with the information indicating that GAN-enabled MSs may find GAN coverage in the geographical area covered by the first GERAN cell C201, is only transmitted in these GERAN cells where a MS really has the possibility to access GAN through a public GAN access point AP211. Those GERAN cells which have only private GAN access points, e.g. AP212 with second MS M202 or no GAN access points at all will not transmit the signal with the new information. In alternative exemplary embodiment, alternative 2 in FIG. 3a, the GAN controller GANC201 forward the reported CGI via RIM, and the indication of public or private GAN coverage which is obtained from e.g. the AP table evaluation. The signal S540,S550 to the BSC, here e.g. first BSC BSC201, is now also containing the information of if public or private GAN coverage is found in first GERAN cell C201. With the information if public or private GAN coverage transmitted in signal S540 from GAN controller GANC201 and transmitted further in S550 and received by BSC BSC201 the contents of the information in first signal S601,S514-517,S522-522 can be varied. The first signal S601 initiated to be transmitted by BSC BSC201 may comprise information S601a indicating if public or private GAN coverage c212 may be found in the geographical area covered by first GERAN cell C201. Another exemplary embodiment could be to transmit the first signal S601,S514 with the information S601a if public or private GAN coverage in an additional information S601b. Further in another exemplary embodiment, the first signal S601 is transmitted, comprising information S601a,S514 comprising at least one GAN ARFCN and the additional information S601b comprising “0” for private and if public the additional information S601b comprising “1”. The contents of first signals S601,S514 is varied according to the description for FIG. 3a.

As mentioned before a GAN registration event is detected each time a GAN-enabled MS with its GAN device turned on finds GAN coverage. If a first signal, here now e.g. S510 is transmitted with information that private GAN coverage is found and a second GAN registration event is detected by a second registering MS, registering a public GAN coverage, the RIM information signals S540,S550 needs to be transmitted to initiate to transmit a first signal S601,S514 now instead of private GAN coverage comprising additional information indicating public GAN coverage. This means also if a third GAN registration is registered of a private GAN coverage no more RIM information is needed to be transmitted as if both public and private GAN coverage is found in a GERAN cell, only the indication of public GAN coverage in first signal S601 is necessary. This is also applicable to when only GAN coverage is indicated, for example if a first signal S601,S510 is transmitted comprising information about GAN coverage in the geographical area covered by first GERAN cell C201 is found and a second registering MS, MS202 registers a second GAN coverage, no need to transmit a second RIM is necessary as it is already a first signal transmitting that GAN coverage can be found in first GERAN cell C201. Another embodiment is also possible if the second registering MS is registering an access point being AP213 in control of a second GAN controller GAN202, then a second RIM S540,S550 may be transmitted to the BSC BSC201, resulting in a first signal S601,S514 transmitting two GAN ARFCN, one for the first GAN controller GANC201 and a second for the second GAN controller GANC202.

Thus the first signal S501 with the information S601a indicating that GAN-enabled MSs may find public or private GAN coverage in the geographical area covered by the first GERAN cell C201 in S514 is transmitted. This is applicable to signal S551,s560,S515-517 and S522-523 as well, see the description for FIG. 5 above for general GAN coverage, with now the more precise additional information if public or private GAN coverage is found in GERAN cell.

To be mentioned the information S601a of the first signal 601 may be provided e.g. in a GAN Neighbouring cell Description information element. And further the first signal S601 may be e.g. a GERAN System Information message or an UTRAN Measurement Control message.

The operator configures manually the GAN Neighbouring Cell Description in a BSC and may set an initial value in additional information for example to “0”.

In signal S540 and S550, correspondingly signal S551 and S560 may beside the information of the CGI of the GERAN cell described above may further be amended with a GAN-CGI (GAN-CGI may be used to route eventual Handover Request from the BSC to the GAN controller), and a GAN Band (the GAN Band allocated for GAN controller information). The GAN-CGI and GAN Band may also be amended with at least one GAN ARFCN as information in first signal initiated to be transmitted by BSC BSC201.

The operator may configure manually the GAN Neighbouring Cell Description in a BSC and may set an initial value in additional information for example to “0”. Also the GAN ARFCN(s), GAN Band(s) and GAN CGI(s) may be configured manually.

FIG. 6 is a block diagram illustrating a first exemplary embodiment of a signal S600 with information according to the invention. A first signal S601 for controlling GAN-enabled MSs MS201-204 operating in a first cell C201 of a cellular radio communication network NET200. The first signal comprising information S601a indicating that the GAN-enabled MSs may find GAN coverage in the geographical area covered by the first cell C201. Further the first signal S601 may comprising information S601a comprising at least one GAN ARFCN. And/or the information S601a may comprising additional information S601b, indicating for the MS MS201-204 whether it may find Private or Public GAN coverage c211,c212 may be found in the geographical area covered by the first cell C201. The information S601a of the first signal 601 may be provided in a GAN Neighbouring cell Description information element. The first signal may be a GERAN System Information message or an UTRAN Measurement Control message. A second signal S602 is also shown in FIG. 6 and may be transmitted as a system information message S602 which does not include in the information S602a/S602b the GAN Neighbouring Cell Description.

FIG. 7 is a block diagram illustrating a first exemplary embodiment of a GAN-enabled MS 700 according to the invention for implementing the method in FIG. 4. A GAN-enabled MS 700 comprising a GAN device 705, and means for receiving 702 a first signal S601 transmitted in a first cell C201 of a cellular radio communication network NET200 in which the GAN-enabled MS is currently operating. The first signal comprising information S601a indicating that the GAN-enabled MSs MS201-204 may find GAN coverage c211 in the geographical area covered by the first cell. The information S601 may comprises additional information S601b indicating whether Public or Private GAN coverage c212 may be found in the geographical area covered by the first cell C201. A GAN-enabled MS 700 may comprising further means 703 for providing an audiovisual indication to a user of the GAN-enabled MS upon receipt of the first signal S600. The audiovisual indication may work in a way giving a sound to the user of the MS MS201 or indicating on a display that the GAN device 705 can be turned on. The display may show or it may sound after the GAN device 705 has been turned on, just to indicate in this scenario that the GAN device 705 has been turned on automatically. The GAN-enabled MS 700 may further comprising means for checking 703, if the additional information S601b received in the first signal S601 indicates Private GAN coverage c212, and if so, whether the MS is associated with a Private GAN access point AP212 providing coverage in the geographical area covered by the first cell C201. The means for checking may also be adapted to check if a CI associated with the first cell is included in a Private GAN coverage list stored in a memory unit of the MS. The GAN-enabled MS 700 may further comprising associating means for 703, and upon a GAN registering event through a Private GAN access point AP211, registering the CI associated with the first cell in the Private GAN coverage list 704.

FIG. 8a-b is a block diagram illustrating a first exemplary embodiment of a function of a control node, here in GERAN a BSC (for implementing the method in FIG. 3a) and a BTS according to the invention. A means for transmitting 801 (e.g. a transmitter 801) and a means for receiving 802 (e.g. a receiver 802) is further involved as a person skilled in the art realizes. The BSC, e.g. BSC201 is actually initiating the BTS (e.g. transmitter 810), e.g. BTS201, as described above to transmit by means of transmitting 811 the signal S600. The control node 800 is operating in the cellular radio communication network NET200 for controlling GAN-enabled MSs MS201-204 operating in a first cell C201 of the cellular radio communication network NET200. The control node 800 comprising means for initiating transmission 801 of a first signal S601 in the first cell, comprising information S601a indicating that the GAN-enabled MSs may find GAN coverage in the geographical area covered by the first cell C201. The control node 800 may further comprising means for initiating transmission of the information S601a of the first signal S601 comprising at least one GAN ARFCN. The control node 800 may further comprising means for initiating transmission of the information S601a of the first signal S601 comprising additional information S601b indicating whether Public c211 or Private GAN coverage c212 may be found for GAN-enabled MSs MS201-204 in the geographical area covered by the first cell C201. The control node 800 may further comprising means for initiating transmission of the first signal s601 comprising the information S601a upon a GAN registration event S530 through a GAN access point AP211 associated with the GAN controller GANC201 providing service in the geographical area covered by the first cell C201. The control node 800 may further comprising means for triggering to initiate transmission upon receiving a request from the GAN controller GANC201, in at least one neighbouring cell C202-204 to the first cell C201, of signals indicating GAN-enabled MSs MS205-210 may find GAN coverage in the at least one neighbouring cell.

In FIG. 9 is a block diagram illustrating a first exemplary embodiment of a function of a GAN controller. A GAN controller 900 comprising means for receiving 902 a CI from a MS MS201 registering through a GAN access point AP211, the CI associated with a first cell C201 in a cellular radio communication network, in which the registering MS is currently operating. The GAN controller comprising means for requesting transmission of a first signal S601 in the first cell C201, the first signal C201 comprising information S601a indicating that GAN-enabled MSs may find GAN coverage c211 in the geographical area covered by the first cell. The GAN controller 900 may further comprising means for distinguishing between Private AP212 or Public AP211 GAN access point, by evaluating an AP table 904. The GAN controller 900 may further comprising means for requesting transmission of the first signal S601 in a RAN-INFORMATION message S601 to a relevant control node BSC201 in control of the first cell.

The methods described here are pure illustrative examples for understanding the invention and many modifications are possible, e.g. some steps/actions may be effectuated in a different/reverse order giving the same result, as a person skilled in the art realizes.

1. A method in a cellular radio communication network for controlling Generic Access Network (GAN) enabled wireless devices, each said GAN-enabled device operating in a first cell of said cellular radio communication network, said method comprising the steps of:
transmitting a first signal in said first cell comprising information indicating that said GAN-enabled device can find GAN coverage in the geographical area covered by said first cell, wherein transmission of said first signal comprising said information is initiated upon a GAN registration event through a GAN access point associated with a GAN controller providing service in the geographical area covered by said first cell.

2. The method according to claim 1, wherein said information comprises at least one GAN Absolute Radio Frequency Channel Number (ARFCN).

3. The method according to claim 1, wherein said information comprises additional information indicating whether Public or Private GAN coverage can be found in the geographical area covered by said first cell

4. The method according to claim 1, wherein said GAN registration event relates to a GAN-enabled device registering through the GAN access point associated with the GAN controller providing service in the geographical area covered by the first cell, wherein said method further comprises the steps of:
receiving a cell identity (CI) associated with the first cell by said GAN controller from the registering device; and,
requesting, by said GAN controller, a relevant control node in control of said first cell to initiate transmission in the first cell of said first signal including said information indicating that GAN-enabled devices can find GAN coverage in the geographical area covered by the first cell.

5. The method according to claim 4, wherein said request to initiate transmission is transmitted from said GAN controller to said relevant control node in a RAN-INFORMATION message.

6. The method according to claim 4, wherein said request from said GAN controller to said relevant control node triggers said relevant control node to initiate transmission, in at least one neighbouring cell to said first cell, said signals indicating GAN-enabled devices can find GAN coverage in said at least one neighbouring cell.

7. The method according to claim 1, wherein said first signal is transmitted to GAN-enabled devices operating in Idle-mode or Dedicated-mode.

8. The method according to claim 1, wherein said information of said first signal is provided in a GAN Neighbouring cell Description information element.

9. The method according to claim 7, wherein said first signal is a GSM EDGE Radio Access Network (GERAN) System Information message or a UMTS Terrestrial Radio Access Network (UTRAN) Measurement Control message.

10. The method according to claim 1, wherein at least one of the GAN devices is a IEEE 802.11 or a Bluetooth device.

11. The method according to claim 1, further comprising the steps of determining or estimating the time elapsed since the last GAN registration event through a GAN access point, and stopping transmission of said first signal when said time exceeds a predetermined value.

12. A control node in a cellular radio communication network for controlling Generic Access Network (GAN) enabled wireless devices operating in a first cell of the cellular radio communication network, comprising:
means for initiating transmission of a first signal in said first cell comprising information indicating that GAN-enabled devices can find GAN coverage in the geographical area covered by said first cell; and,
wherein said transmission of said first signal comprising said information is initiated upon a GAN registration event through a GAN access point associated with said GAN controller providing service in the geographical area covered by said first cell.

13. The control node according to claim 12, wherein said information of said first signal comprises at least one GAN Absolute Radio Frequency Channel Number (ARFCN).

14. The control node according to claim 12, wherein said first signal comprises additional information indicating whether Public or Private GAN coverage can be found in the geographical area covered by said first cell.

15. (canceled)
